(19) United States
(12) Patent Application Publication
(10) Pub. No.: US 2008/0119949 A1
(43) Pub. Date: May 22, 2008

(54) Shipping management system

(76) Inventors: Bradley P. Gile, Dunlap, IL (US); Seth A. Johnsen, Metamora, IL (US); Jennifer L. Crompton, Morton, IL (US); Barbara J. Church, East Peoria, IL (US); Brad Shapland, Metamora, IL (US); Ma Jun, Shanghai (CN); Jeremy Moza, Morton, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/602,372

(22) Filed: Nov. 21, 2006

(51) Int. Cl. G05B 13/02

(52) U.S. Cl. 700/28

(57) ABSTRACT

A computer-readable medium is provided, having stored thereon instructions for performing a shipping management method. The method may include generating an advanced shipping notice for a first container being shipped for a customer. The method may also include checking the advanced shipping notice for missing information related to one or more parts in the first container, the information including at least one of a part description, a part grouping, and a tariff code. In addition, the method may include retrieving any missing information from a database and including the missing information on the advance shipping notice.

### TECHNICAL FIELD

The present disclosure is directed to a shipping management system and, more particularly, to a shipping management system having data correction features.

### BACKGROUND

In certain countries, Customs laws and regulations dictate that goods shipped in bulk to the country for purposes of distribution may be stored in a bonded warehouse. A bonded warehouse is a storage facility in which importers are allowed to keep their imported goods without having to pay duty or tariff for a predetermined amount of time (typically up to one year) as long as the goods do not leave the warehouse. Importers post a bond in order to be afforded this privilege. This enables the importers to store the imported goods in the country without having to pay duty or tariff until the goods are distributed from the warehouse. In effect, the goods are not “in the country,” as far as Customs is concerned, until the importer is set to distribute the goods from the warehouse.

When the importer decides to distribute goods from the warehouse, the goods must pass Customs clearance before leaving the warehouse. In addition, the warehouse must be guarded by Customs agents or agents working on Customs' behalf because the goods in the warehouse have not cleared Customs yet. In effect, Customs guards the warehouse as though it were a port of entry. Because there is a Customs clearance process at the time the goods are distributed, there can be delays in obtaining that clearance, which can hold up delivery of the goods. Delays in obtaining clearance can be caused by, among other things, problems with shipping and storage records, such as incorrect, inconsistent, missing, or otherwise inaccurate product, shipping, and storage information. Further, even when all the information required to clear Customs is present and accurate, the Customs clearance process itself can cause a delay.

Systems have been developed to manage shipping data. For example, U.S. Patent Application No. 2005/0187874, to Sanal (the '874 publication), discloses an import compliance system. The system disclosed by the '874 publication is configured to flag invalid or missing classification of one or more identifiers against a classification system prior to submission of commercial invoice data to Customs. However, while the system of the '874 publication may automatically detect invalid or missing data, the '874 publication does nothing to remedy or even promote correction of the invalid or missing data, nor does it alleviate the need for Customs to guard the warehouse.

The present disclosure is directed to overcoming one or more of the problems discussed above.

### SUMMARY OF THE INVENTION

In one aspect, the present disclosure is directed to a computer-readable medium having stored thereon instructions for performing a shipping management method. The method may include generating an advanced shipping notice for a first container being shipped for a customer. The method may also include checking the advanced shipping notice for missing information related to one or more parts in the first container, the information including at least one of a part description, a part grouping, and a tariff code. In addition, the method may include retrieving any missing information from a database and including the missing information on the advance shipping notice.

In another aspect, the present disclosure is directed to a shipping management method. The method may include generating an advanced shipping notice for a first container being shipped for a customer. The method may also include checking the advanced shipping notice for missing information related to one or more parts in the first container, the information including at least one of a part description, a part grouping, and a tariff code. In addition, the method may include retrieving any missing information from a database and including the missing information on the advance shipping notice.

In another aspect, the present disclosure is directed to a shipping management system. The system may include a display device configured to display information. The system may also include an input device configured to accept user input regarding shipping data for one or more items. Further, the system may include a processor configured to process accepted shipping data and a computer-readable medium operatively coupled to the processor. The computer-readable medium may having stored thereon instructions for performing a shipping management method. The method may include generating an advanced shipping notice for a first container being shipped for a customer. The method may also include checking the advanced shipping notice for missing information related to one or more parts in the first container, the information including at least one of a part description, a part grouping, and a tariff code. In addition, the method may include retrieving any missing information from a database and including the missing information on the advance shipping notice. Further, the method may include and displaying information regarding the shipping management method using the display device.

### BRIEF DESCRIPTION OF THE DRAWINGS

FIG. 1 is a diagrammatic representation of a shipping management system according to an exemplary disclosed embodiment.

FIG. 2 is a flow chart illustrating aspects of a shipping management method according to an exemplary disclosed embodiment.

### DETAILED DESCRIPTION

Reference will now be made in detail to the drawings. Wherever possible, the same reference numbers will be used throughout the drawings to refer to the same or like parts.

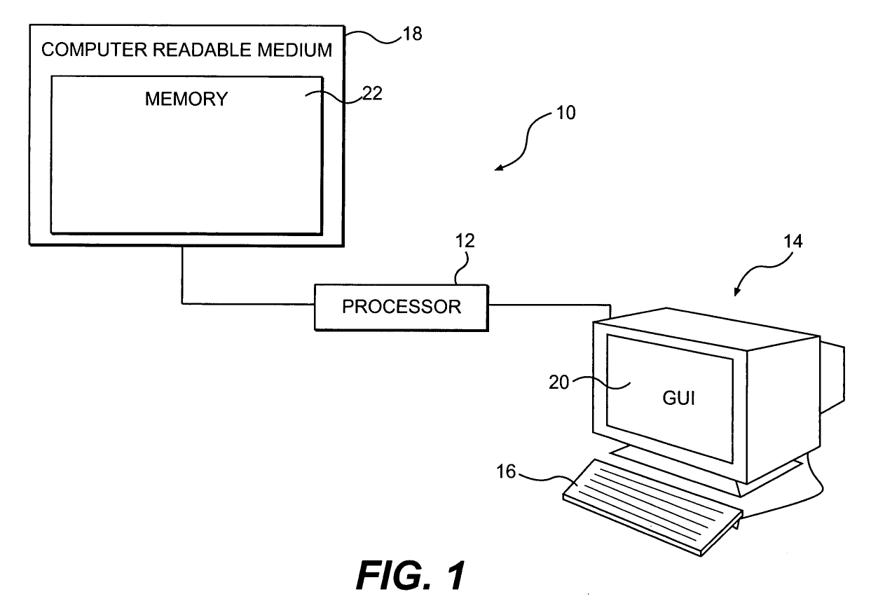

FIG. 1 illustrates a shipping management system 10. System 10 may include a processor 12, a display device 14, an input device 16, and a computer-readable medium 18 operatively coupled to processor 12.

Display device 14 may include any type of display equipment configured to provide visual feedback regarding system 10 and its components and functions. Display device 14 may include any of a number of screen type displays, such as, for example, a cathode ray tube (CRT) as shown in FIG. 1, a liquid crystal display (LCD), a plasma screen, or the like. Display device 14 may be configured to display an input interface 20. Input interface 20 may be displayed in any format suitable for accepting data entry. Display device 14 may also provide other information regarding any other device and/or system associated with system 10. System 10 may be Internet-based and, as such, input interface 20 may be displayed by display device 14 as one or more web pages available on a local or global network.

Input device 16 may include any type of devices suitable for inputting data (e.g., to accept user input regarding shipping data for one or more items) and/or navigating through screens/menus that may be displayed by display device 14. For example, input device 16 may include a keyboard (as shown in FIG. 1), mouse, etc. In some embodiments, input device 16 may be at least partially integrated with display device 14. In such embodiments, display device 14 may include, for example, a touch screen.

Although system 10 is illustrated as including a desktop computer, wherein display device 14 includes a CRT monitor, system 10 may alternatively or additionally include a portable, and in some cases, handheld unit (not shown). Exemplary portable or handheld units may include laptops, personal data assistants (PDAs), or other devices distinctly designed for use with system 10.

Computer-readable medium 18 may include any type of computer-readable medium including, for example, computer chips and secondary storage devices, including hard disks, floppy disks, optical media, CD-ROM, or other forms of RAM or ROM. Computer-readable medium 18 may include a memory 22 in which may be stored instructions for performing a shipping management method.

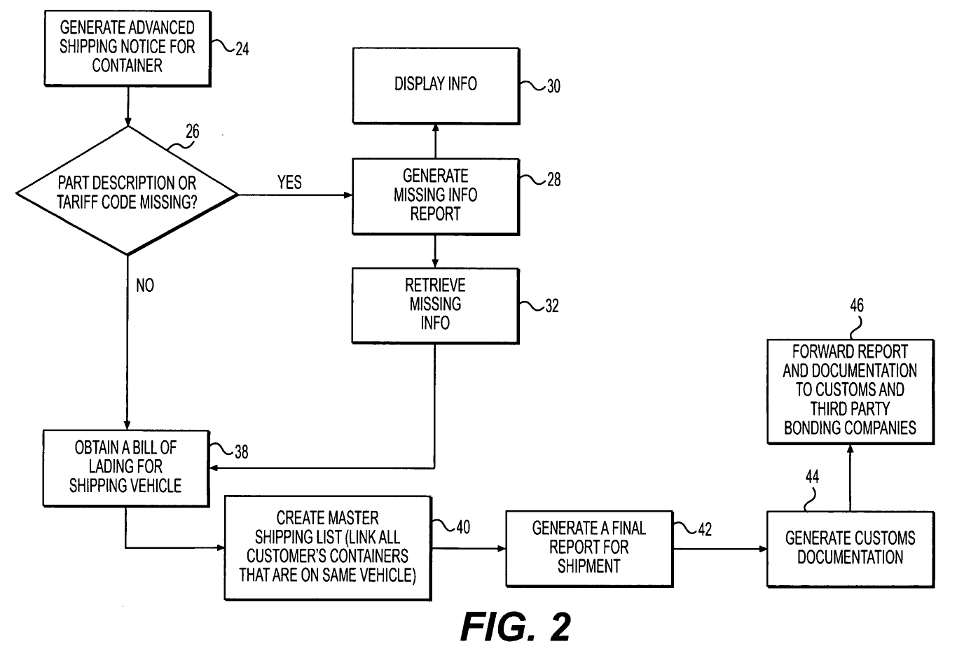

FIG. 2 illustrates an exemplary shipping management method for which computer-readable medium 18 may include instructions. As shown in FIG. 2, the method may include generating an advanced shipping notice for a first container being shipped for a customer (step 24). The customer could be the person or persons who are sending the container or the person or persons who are receiving the container. The method may also include automatically checking the advanced shipping notice for missing information related to one or more parts in the first container (step 26). The missing information may include, for example, part descriptions and/or tariff codes. Other possible information to be checked may include part groupings. For example, tires may be classified in multiple part groupings, such as on-road tires and off-road tires.

Alternatively or additionally, this or other information on the advanced shipping notice may be checked, not only for its presence, but for accuracy. The method may further include generating a report for any missing (or inaccurate) information that has been identified (step 28).

Further, the method may include displaying information regarding the shipping management method using display device 14 (step 30). Although displaying information is illustrated at step 30, any information may be displayed at any time during the method.

The method may include retrieving any missing information from a database and including the missing information on the advance shipping notice (step 32). Tariff codes may be chosen from, for example, the Harmonized Tariff Schedule (HTS). If HTS codes are missing from the advanced shipping notice, the method may include automatically retrieving an appropriate HTS code for the part in question. As part of the method, this retrieved HTS code may be furnished as a provisional code for approval by Customs. For example, when a part is being shipped to a foreign country for the first time, it may be required to be assigned an HTS code that is approved by Customs in the foreign country. System 10 may be configured to provide an advanced shipping notice that includes the HTS code that has been approved in the country of origin as a suggestion to be submitted for approval by foreign Customs. In some cases, system 10 may be configured to furnish the HTS code that has been approved by foreign Customs for other similar parts.

In some embodiments, the method may include obtaining a bill of lading for an air, sea, or land-going vehicle moving the container (step 38). The bill of lading may include information about other containers on the vehicle that are being shipped for the customer. The method may include linking together all containers being shipped on the vehicle for the customer, thereby creating a master shipping list for processing as a single shipment (step 40).

In addition, the method may further include automatically generating a final report (step 42) and all necessary Customs documentation (step 44) for the shipment. In some embodiments, the method may include forwarding the final report to Customs and any third party bonding companies and import companies (step 46). The final report and/or Customs documentation may be forwarded to such entities using a web portal, email, or other electronic notification tool.

### INDUSTRIAL APPLICABILITY

The presently disclosed system may be applicable to management of international shipping of goods. In particular, the disclosed system may be utilized to facilitate record keeping and document production, with particular regard to Customs clearance. However, the system may also be applicable to any shipping and/or storage management system.

The disclosed system may be configured to automatically identify missing and/or inaccurate product and/or shipping information. In particular, the system may be configured to check for the presence and, in some embodiments, the correctness, of tariff codes, product descriptions, and/or product groupings. The system may be configured to automatically retrieve correct information for any missing or inaccurate information that is identified. This information may then be sent in an advanced shipping notice to an employee or agent of the customer at the destination in order to insure that all required information is acquired prior to the shipment arriving. For example, if provisional information (e.g., suggested HTS codes) are included, the employee or agent may submit for customs approval and or correction of the HTS code, so that such information is available for registering the shipment and/or product at the time it arrives at the destination, rather than having to wait for further Customs approval.

Customs may be allowed access to the system to monitor, for themselves, the shipping management. In addition, because Customs has access to the system and is able to monitor the shipping and storage information, the storage facility does not need to be guarded by Customs.

Further, because Customs is able to closely monitor the shipping and storage management, Customs may, in some cases, grant batch clearance to shipments, which may be cleared after the shipped goods leave the bonded warehouse. In other words, while Customs would typically require goods to remain in the warehouse until they have received Customs clearance (thus causing additional delays), but because Customs has greater confidence in the shipping management system, and has access to the system, Customs may allow goods to leave the warehouse without clearance and then process the clearance at a later time. For example, the customer may submit for batch clearance on all goods distributed from the warehouse over the course of a predetermined period of time, such as one week.

Therefore, the disclosed system may save time and/or money for both customers and Customs. An exemplary shipping management method, for which the disclosed system may include instructions may include the following. The method may include generating an advanced shipping notice for a first container being shipped for a customer. The method may also include checking the advanced shipping notice for missing information related to one or more parts in the first container, the information including at least one of a part description, a part grouping, and a tariff code. The method may also include retrieving any missing information from a database and including the missing information on the advance shipping notice. The method may further include generating a report regarding the missing information.

In some embodiments, the exemplary method may include obtaining a bill of lading for an air, sea, or land-going vehicle moving the container. The bill of lading may also include information about other containers on the vehicle that are being shipped for the customer. The method may further include linking together all containers being shipped on the vehicle for the customer, thereby creating a master shipping list for processing as a single shipment.

In some embodiments, the method may include automatically generating a final report and/or all necessary Customs documentation for the shipment. The method may also include forwarding the final report to Customs and any third party bonding companies and import companies. The shipping information and the final report may be provided to Customs using a web portal, (e.g., the Internet), email, etc.

It will be apparent to those having ordinary skill in the art that various modifications and variations can be made to the disclosed shipping management system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A computer-readable medium having stored thereon instructions for performing a shipping management method, comprising:
generating an advanced shipping notice for a first container being shipped for a customer;
checking the advanced shipping notice for missing information related to one or more parts in the first container, the information including at least one of a part description, a part grouping, and a tariff code; and
retrieving any missing information from a database and including the missing information on the advance shipping notice.

2. The computer-readable medium of claim 1, wherein the method further includes generating a report regarding the missing information.

3. The computer-readable medium of claim 1, wherein the method further includes obtaining a bill of lading for an air, sea, or land-going vehicle moving the container.

4. The computer-readable medium of claim 3, wherein the bill of lading also includes information about other containers on the vehicle that are being shipped for the customer.

5. The computer-readable medium of claim 4, wherein the method further includes linking together all containers being shipped on the vehicle for the customer, thereby creating a master shipping list for processing as a single shipment.

6. The computer-readable medium of claim 5, wherein the method further includes automatically generating, for the shipment, a final report and all necessary Customs documentation.

7. The computer-readable medium of claim 6, wherein the method further includes forwarding the final report to Customs.

8. The computer-readable medium of claim 7, wherein the method further includes providing shipping information and the final report to Customs using a web portal.

9. A shipping management method, comprising:
generating an advanced shipping notice for a first container being shipped for a customer;
checking the advanced shipping notice for missing information related to one or more parts in the first container, the information including at least one of a part description, a part grouping, and a tariff code; and
retrieving any missing information from a database and including the missing information on the advance shipping notice.

10. The method of claim 9, further including generating a report regarding the missing information.

11. The method of claim 9, further including obtaining a bill of lading for an air, sea, or land-going vehicle moving the container.

12. The method of claim 11, wherein the bill of lading also includes information about other containers on the vehicle that are being shipped for the customer.

13. The method of claim 12, further including linking together all containers being shipped on the vehicle for the customer, thereby creating a master shipping list for processing as a single shipment.

14. The method of claim 13, further including automatically generating, for the shipment, a final report and all necessary Customs documentation.

15. The method of claim 14, further including forwarding the final report to Customs.

16. The method of claim 15, further including providing shipping information and the final report to Customs using a web portal.

17. A shipping management system, comprising:
a display device configured to display information;
an input device configured to accept user input regarding shipping data for one or more items;
a processor configured to process accepted shipping data; and
a computer-readable medium operatively coupled to the processor and having stored thereon instructions for performing a shipping management method including:
generating an advanced shipping notice for a first container being shipped for a customer;
checking the advanced shipping notice for missing information related to one or more parts in the first container, the information including at least one of a part description, a part grouping, and a tariff code;
retrieving any missing information from a database and including the missing information on the advance shipping notice; and
displaying information regarding the shipping management method using the display device.

18. The system of claim 17, wherein the method further includes generating a report regarding the missing information.

19. The system of claim 17, wherein the method further includes obtaining a bill of lading for an air, sea, or land-going vehicle moving the container; and
wherein the bill of lading also includes information about other containers on the vehicle that are being shipped for the customer, and linking together all containers being shipped on the vehicle for the customer, thereby creating a master shipping list for processing as a single shipment.

20. The system of claim 19, wherein the method further includes:
automatically generating, for the shipment, a final report and all necessary Customs documentation; and
forwarding the final report to Customs.
